(19) United States
(12) Patent Application Publication
(10) Pub. No.: US 2009/0025988 A1
(43) Pub. Date: Jan. 29, 2009

(54) Serpentine Robotic Crawler Having A Continuous Track

(76) Inventors: Stephen C. Jacobsen, Salt Lake City, UT (US); Ralph W. Pensel, Sandy, UT (US); Marc X. Olivier, Sandy, UT (US); Fraser M. Smith, Salt Lake City, UT (US)

Correspondence Address: THORPE NORTH & WESTERN, LLP., P.O. Box 1219, SANDY, UT, 84091-1219, US

(21) Appl. No.: 12/171,144

(22) Filed: Jul. 10, 2008

Related U.S. Application Data
(60) Provisional application No. 60/959,089, filed on Jul. 10, 2007.

(51) Int. Cl. B62D 55/07; B62D 55/00; B62D 55/065

(52) U.S. Cl. 180/9.32; 180/9.1; 901/1

(57) ABSTRACT

A serpentine robotic crawler includes an articulated body having at least two body segments serially connected and a continuous track operably supported along a perimeter of the articulated body. The serpentine robotic crawler is capable of a variety of movement modes and poses.

### RELATED APPLICATIONS

This application claims the benefit of U.S. Provisional Patent Application No. 60/959,089, filed Jul. 10, 2007, and entitled, “Serpentine Robotic Crawler Having A Continuous Track,” which is incorporated by reference in its entirety herein.

### FIELD OF THE INVENTION

The present invention relates to robotic vehicles. More particularly, the present invention relates to a serpentine robotic crawler having a continuous track.

### BACKGROUND OF THE INVENTION AND RELATED ART

Robotics is an active area of research, and many different types of robotic vehicles have been developed for various tasks. For example, unmanned aerial vehicles have been quite successful in military aerial reconnaissance. Less success has been achieved with unmanned ground vehicles, however, in part because the ground environment is significantly more difficult to traverse than the airborne environment.

Unmanned ground vehicles face many challenges when attempting mobility. Terrain can vary widely, including for example, loose and shifting materials, obstacles, vegetation, limited width or height openings, steps, and the like. A vehicle optimized for operation in one environment may perform poorly in other environments.

There are also tradeoffs associated with the size of vehicle. Large vehicles can handle some obstacles better, including for example steps, drops, gaps, and the like. On the other hand, large vehicles cannot easily negotiate narrow passages or crawl inside pipes, and are more easily deterred by vegetation. Large vehicles also tend to be more readily spotted, and thus are less desirable for discrete surveillance applications. In contrast, while small vehicles are more discrete, surmounting obstacles becomes a greater navigational challenge.

A variety of mobility configurations has been adapted to traverse difficult terrain. These options include legs, wheels, and tracks. Legged robots can be agile, but use complex control mechanisms to move and achieve stability. Wheeled vehicles can provide high mobility, but provide limited traction and require width in order to achieve stability.

Tracked vehicles are known and have traditionally been configured in a tank-like configuration. While tracked vehicles can provide a high degree of stability in some environments, tracked vehicles typically provide limited maneuverability with very small vehicles. Furthermore, known tracked vehicles are unable to accommodate a wide variety of obstacles, particularly when the terrain is narrow and the paths are tortuous and winding.

### SUMMARY OF THE INVENTION

The present invention includes a serpentine robotic crawler which helps to overcome problems and deficiencies inherent in the prior art. In one embodiment, the serpentine robotic crawler includes at least two body segments serially connected by at least one joint to enable the crawler body to articulate and adapt to travel through an operating environment. A continuous track is supported along a perimeter of the crawler body to encompass the crawler body while the serpentine robotic crawler is operated. The continuous track provides propulsion to the serpentine robotic crawler via a surface interface with the operating environment.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, can be arranged and designed in a wide variety of different configurations. Nonetheless, the invention will be described and explained with additional specificity and detail through the use of the accompanying drawings in which:

FIG. 1 illustrates a perspective view of a serpentine robotic crawler according to an exemplary embodiment of the present invention;

FIG. 2 illustrates a top view of a portion of a continuous track in accordance with an embodiment of the present invention;

FIG. 3 illustrates a side cross section view of a continuous track operably supported by a body segment in accordance with one embodiment of the present invention;

FIG. 4 illustrates a side cross section view of a continuous track operably supported by a body segment in accordance with another embodiment of the present invention;

FIG. 5 illustrates a side cross section view of a continuous track operably supported by a body segment in accordance with yet another embodiment of the present invention;

FIG. 6 illustrates a side view of a serpentine robotic vehicle moving in a substantially straight line in accordance with an embodiment of the present invention;

FIG. 7 illustrates a top view of a serpentine robotic vehicle moving in a curved path in accordance with an embodiment of the present invention;

FIG. 8 illustrates a top view of a serpentine robotic vehicle moving in a serpentine path in accordance with an embodiment of the present invention;

FIG. 9 illustrates a side view of a serpentine robotic vehicle raising a leading portion to overcome an obstacle in accordance with an embodiment of the present invention;

FIG. 10 illustrates a side view of a serpentine robotic vehicle cantilevering over a gap in accordance with an embodiment of the present invention;

FIG. 11 illustrates a side view of a serpentine robotic vehicle climbing up the outside of a pole in accordance with an embodiment of the present invention;

FIG. 12 illustrates a side view of a serpentine robotic vehicle climbing inside a pipe in accordance with an embodiment of the present invention;

FIG. 13 illustrates a flow chart of a method of moving a serpentine robotic crawler along a supporting surface in accordance with an embodiment of the present invention;

FIG. 14 illustrates a side view of a serpentine robotic crawler in a train configuration in accordance with an embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

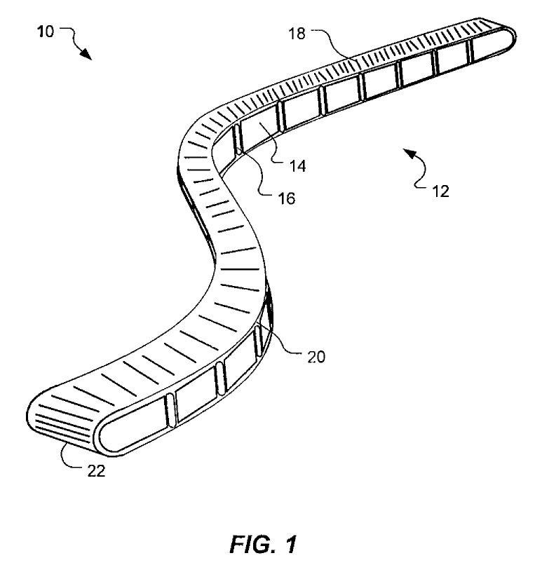

With reference to FIG. 1, shown is an illustration of a serpentine robotic crawler according to a first exemplary embodiment of the present invention. Specifically, FIG. 1 illustrates the crawler 10 as including a crawler body 12 made up of at least two body segments 14 serially connected by at least one joint 16. The joint provides at least one degree of freedom, although it will be appreciated that two or three degrees of freedom provide greater flexibility in the movement of the crawler. For example, the joint(s) may provide for rotation about a longitudinal axis of the crawler and bending in one or more directions perpendicular to the longitudinal axis of the crawler. Because the body segments are connected by joints, the crawler body is able to articulate and adapt to travel through an operating environment.

A continuous track 18 is disposed and operably supported along a perimeter 20 of the crawler body to encompass the crawler body. In other words, the continuous track conforms to and circumnavigates the crawler body. The continuous track is configured to conform to the perimeter of the crawler body as the serpentine robotic crawler is operated. The continuous track can provide propulsion to the serpentine robotic crawler via a surface interface 22 with the operating environment. For example, one or more portions of the continuous track may be in contact with a supporting surface in the operating environment and thereby provide a frictional interface to the supporting surface that can be used for propulsion. The crawler can be moved by rotating the continuous track around the crawler body. Movement can be in a generally forward or reverse direction, depending on the direction of rotation of the continuous track.

Steering of the serpentine robotic crawler 10 can be provided by articulating the body 12 while moving. For example, bending of the joints 16 between the body segments can cause the crawler to bend or flex in a snake-like manner. The continuous track 18 continues to conform to the body as it is bent or flexed. Accordingly, the robotic crawler can be made to move within an environment in a variety of modes as will be detailed further below.

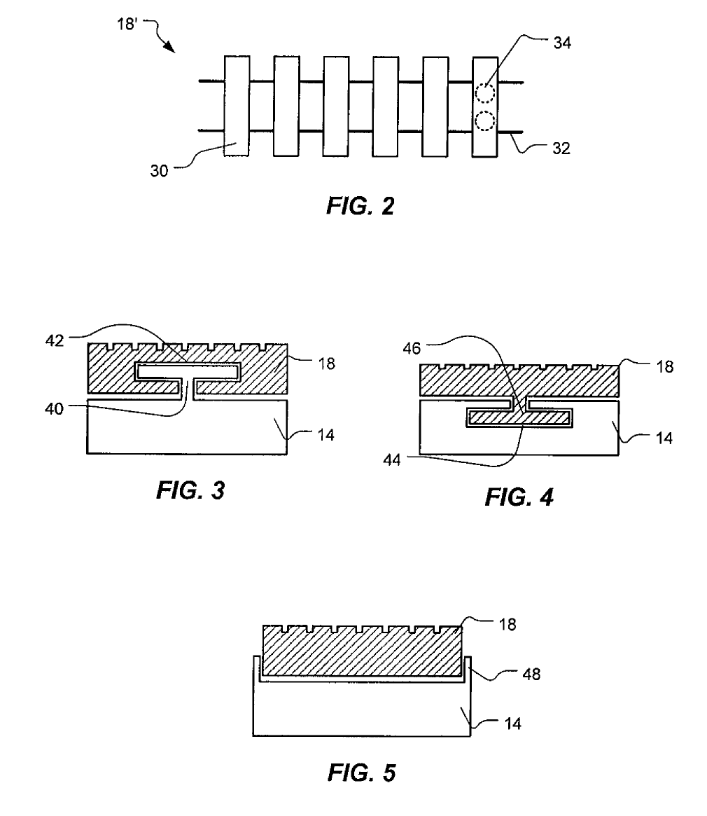

Various configurations of the continuous track can be used. In one embodiment, illustrated in FIG. 2, the continuous track 18′ can include a plurality of track pads 30 intercoupled by a plurality of tendons 32. The track pads can be of various types to provide traction as desired. For example, commonly-owned and co-pending U.S. patent application Ser. No. 11/985,346, filed Nov. 13, 2007, entitled “Versatile Endless Track for Lightweight Mobile Robots,” incorporated herein by reference, describes an endless track with interchangeable track pads which can be used in embodiments of the present invention.

Means for wrapping and unwrapping the tendons 32 to maintain constant tension within the continuous track 18′ can be disposed within the track pads 30. For example, the means for wrapping and unwrapping can include spools 34. For example, bending of the track between two track pads can be performed by reducing the length of one tendon while increasing the length of the other tendon. In other words, the track pads need not remain parallel, as the lengths of the tendons are adjusted between the track pads. This can provide for bending of the track to maintain the track conformed to the body.

Bending is also possible in other directions, due to the flexibility of the tendons. For example, bending of the continuous track 18′ in three degrees of freedom are possible: lateral bending about an axis oriented perpendicular to the paper in FIG. 2 (e.g. yaw); lateral bending about an axis within the plane of the paper and oriented perpendicular with the tendons in FIG. 2 (e.g. pitch); and longitudinal bending or twisting about an axis within the plane of the paper and oriented parallel with the tendons in FIG. 2 (e.g. roll).

The tendons 32 may be a high strength flexible fiber material, including for example, ultra-high molecular weight polyethylene (e.g., Spectra® fiber) and para-aramid type fibers (e.g. Kevlar® fiber).

In another embodiment, the continuous track can include a plurality of pivoting joints. The joints can include at least two degrees of freedom. For example, joints within the continuous track can provide similar bending capability as the joints between the body segments. In another embodiment, the continuous track can be a continuous flexible belt. For example, a flexible belt can be made of a polymer or rubber material.

The continuous track conforms to the perimeter of the crawler body. The perimeter can be the top, bottom, and two end surfaces of the crawler body. Various ways of maintaining the continuous track along the perimeter of the crawler body can be used. For example, as illustrated in FIG. 3, the body segments 14 may include a protrusion 40 to interlock into a corresponding groove 42 within the continuous track 18. Alternately, as illustrated in FIG. 4, the body segments may include a groove 44 to interlock with a corresponding protrusion 46 in the continuous track. As another example, shown in FIG. 5, the body segments may include lateral guides 48. For the example of FIG. 5, sufficient tension may be maintained within the continuous track to help keep it conformed to the body.

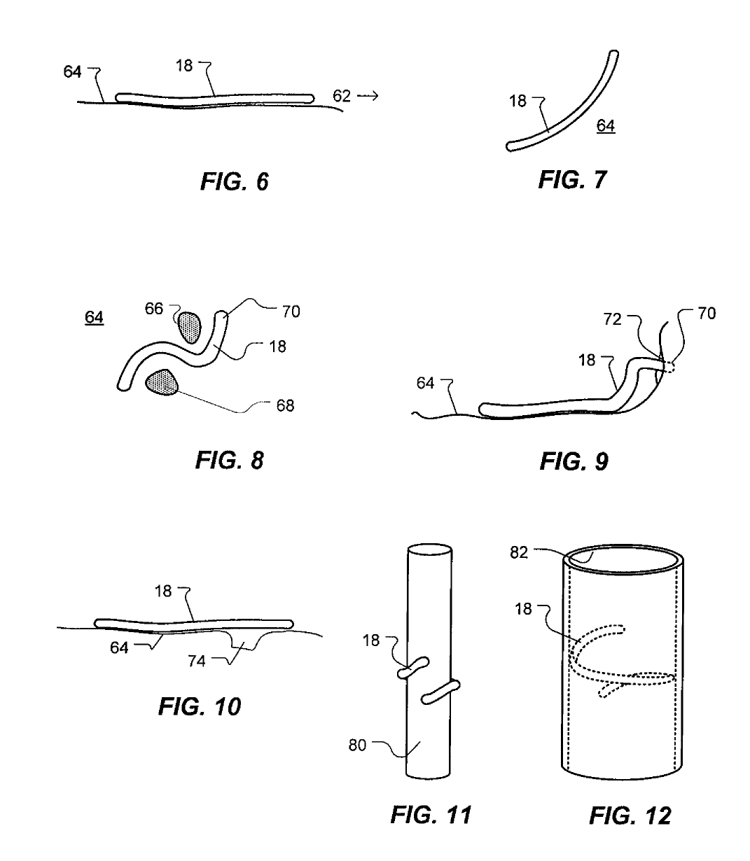

Various movement modes are possible for the serpentine robotic crawler 10 as will now be described. For example, as illustrated in side view in FIG. 6, the serpentine robotic crawler 10 can be moved in a generally straight path 62 by articulating the body 14 into a generally straight arrangement and rotating the continuous track 18 to move the serpentine robotic crawler forward or backward over the supporting surface 64. For uneven surfaces, the body may be articulated to arch portions upward or downward to maintain contact with the supporting surface, helping to maintain traction. The serpentine robotic crawler can be turned, as illustrated in top view in FIG. 7, by bending the body in a generally left or right direction.

High traction forces can be provided by the continuous track even when the serpentine robotic crawler is articulated around or through obstacles. For example, as shown in top view in FIG. 8, the crawler can snake its way around obstacles 66, 68 by curving the body 18 as the crawler moves. As track pads rotate around the perimeter of the body, they come into contact with the supporting surface 64 as they rotate down the leading portion of the body 70. Once the track pads are placed into contact with the supporting surface, they can be held in a substantially fixed position relative to the supporting surface. As the serpentine robotic crawler moves forward, the body is articulated so that the body segments follow each other on a substantially coincident path. This helps to minimize the development of lateral forces on the track pads that might cause slippage or loss of traction.

Another mode of operation includes lifting a leading portion of the body above a supporting surface. For example, as shown in FIG. 9, the leading portion 70 of the body 14 may be lifted to allow the serpentine robotic crawler to enter a hole 72. Similar movements may be used to help climb over a ledge or up stairs. As shown in FIG. 10, the body can also be cantilevered over a gap 74, hole, or hollow in the supporting surface.

In addition to traveling on a relatively horizontal surface as described above, the serpentine robotic crawler is also capable of climbing various structures. For example, as illustrated in FIG. 11, the serpentine robotic crawler can climb a pole or other generally convex supporting surface 80. The body is wrapped at least partially around the supporting surface and contracted to increase friction forces between the supporting surface and the portion of the continuous track in contact with the supporting surface. The continuous track may then be rotated to move the crawler up or down the convex supporting surface, for example, spiraling up or down the outside of a pole or similar structure.

As another example, as illustrated in FIG. 12, the serpentine robotic crawler can also climb inside a pipe or other generally concave supporting surface 82. The body is wrapped at least partially within the concave supporting surface and articulated to press the body outwardly against the supporting surface to increase friction forces between the supporting surface and the portion of the continuous track in contact with the supporting surface. The continuous track may be rotated to move the crawler up or down the concave supporting surface, for example, spiraling up or down inside a pile or similar structure.

Other movement modes are also possible which do not involve the use of the continuous track to provide propulsion. For example, the joints can be articulated to provide serpentine movement, such as slithering in a snake-like manner and sidewinding by dual orthogonal translating sinusoidal segment actuation. Concertina movement can be achieved by lateral bending, folding, and then extension like an earthworm. Caterpillar-like movement can be achieved by axial rippling, rolling, etc. Various other movement modes are possible as well.

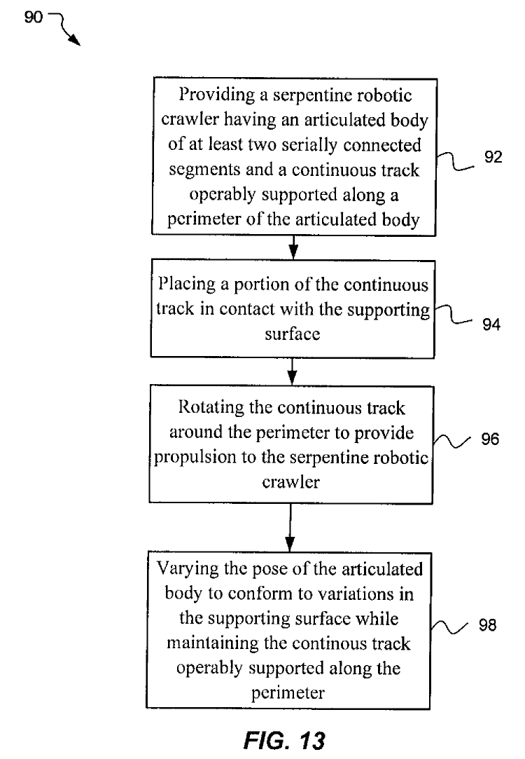

A method of moving a serpentine robotic crawler along a supporting surface will be described in conjunction with FIG. 13. The method 90 can include providing 92 a serpentine robotic crawler having an articulated body of at least two serially connected segments and a continuous track operably supported along a perimeter of the articulated body. The method can include placing 94 a portion of the continuous track in contact with the supporting surface. The method can also include rotating 96 the continuous track around the perimeter to provide propulsion to the serpentine robotic crawler. The method can also include varying 98 the pose of the articulated body to conform to variations in the supporting surface while maintaining the continuous track operably supported along the perimeter. For example, various poses are illustrated above in FIGS. 6-12 that the serpentine robotic crawler can be positioned into and transitioned between.

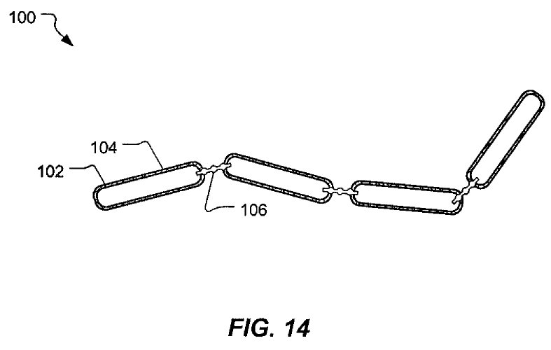

Another embodiment of a serpentine robotic crawler can include multiple crawlers as described above, the crawlers being connected together by articulated links. For example, FIG. 14 illustrates a serpentine robotic crawler in a train configuration 100 having a plurality of crawler bodies 102, each crawler body having a continuous track 104 supported along a perimeter of the crawler body. The crawler body may include at least two body segments serially connected by at least one joint, for example as described above. A plurality of articulated links 106 couple the crawler bodies together. The articulated links can include joints and actuators. For example, the articulated joint can include a multiple degree of freedom linkage arm as described in commonly-owned and co-pending U.S. patent application Ser. No. 11/985,323, entitled “Serpentine Robotic Crawler,” filed Nov. 13, 2007, which is incorporated herein by reference.

Summarizing and reiterating to some extent, a serpentine robotic crawler in accordance with embodiments of the present invention can be deployed in a variety of applications and environments. For example, and not by way of limitation, applications can include search and rescue, military operations, and industrial operations. The serpentine robotic crawler can help to avoid the need to expose humans to hazardous environments. The flexibility of the serpentine robotic crawler can allow the device to navigate environments that would normally be difficult to insert a robotic vehicle into. The varied movement modes allow adaptation to a variety of environments. For example, the serpentine robotic crawler can move across surfaces, enter small openings, span gaps, and climb inside or outside various structures.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present: a) “means for” or “step for” is expressly recited in that limitation; b) a corresponding function is expressly recited in that limitation; and c) structure, material or acts that support that function are described within the specification. Accordingly, the scope of the invention should be determined solely by the appended claims and their legal equivalents, rather than by the descriptions and examples given above.

What is claimed is:

1. A serpentine robotic crawler comprising:
a crawler body having at least two body segments serially connected by at least one joint to enable the crawler body to articulate and adapt to travel through an operating environment; and
a continuous track operably supported along a perimeter of the crawler body to encompass the crawler body while the serpentine robotic crawler is operated, the continuous track being configured to provide propulsion to the serpentine robotic crawler via a surface interface with the operating environment.

2. The apparatus of claim 1, wherein the continuous track comprises a plurality of track pads intercoupled by a plurality of tendons, the track pads comprising means for wrapping and unwrapping the tendons to maintain constant tension within the continuous track.

3. The apparatus of claim 2, wherein the tendons comprise a fiber selected from the group consisting of ultra-high molecular weight polyethylene and para-aramid.

4. The apparatus of claim 1, wherein the continuous track comprises a continuous flexible belt.

5. The apparatus of claim 1, wherein the continuous track comprises a protrusion interlocking into a corresponding groove disposed with the perimeter of the crawler body to conform the continuous track to the crawler body.

6. The apparatus of claim 1, wherein the continuous track comprises an internal groove interlocking onto a corresponding protrusion disposed along the perimeter of the crawler body to conform the continuous track to the crawler body

7. The apparatus of claim 1, wherein the at least one joint has at least two degrees for freedom.

8. The apparatus of claim 1, further comprising:
a second crawler body having a second continuous track operably supported along a perimeter of the second crawler body; and
an articulated link coupling the crawler body to the second crawler body.

9. The apparatus of claim 1, further comprising:
a plurality of crawler bodies each having a continuous track operably supported along corresponding perimeters; and
a plurality of articulated links coupling the crawler bodies into a train.

10. A serpentine robotic crawler comprising:
an articulated crawler body, having at least two body segments serially connected by at least one joint to form an articulated shape; and
a continuous track operably coupled to and encompassing the articulated crawler body, the continuous track having a plurality of pivoting joints, each joint having at least two degrees of freedom to enable the track to conform to the articulated shape of the crawler body.

11. The apparatus of claim 10 wherein one of the at least two degrees of freedom provides rotation about a longitudinal axis of the articulated crawler body.

12. The apparatus of claim 10 wherein the continuous track comprises a plurality of track pads intercoupled by a plurality of tendons, the tendons providing flexure in at least a first dimension and the track pads including means for wrapping and unwrapping the tendons in at least a second dimension so that the tendons maintain a substantially constant tension within the continuous track.

13. A method for moving a serpentine robotic crawler having an articulated body of at least two serially connected segments along a supporting surface, the method comprising:
providing a continuous track operably supported along a perimeter of the articulated body;
placing a portion of the continuous track in contact with the supporting surface;
rotating the continuous track around the perimeter to provide propulsion to the serpentine robotic crawler; and
varying the pose of the articulated body to conform to variations in the supporting surface while maintaining the continuous track operably supported along the perimeter.

14. The method of claim 13, wherein varying the pose of the articulated body further comprises:
wrapping at least a portion of the articulated body around a convex supporting surface; and
contracting the articulated body against the supporting surface to increase friction forces between the supporting surface and the portion of the continuous track in contact with the supporting surface.

15. The method of claim 13, wherein varying the pose of the articulated body further comprises:
wrapping at least a portion of the articulated body within a concave supporting surface; and
pressing the articulated body outwardly against the supporting surface to increase friction forces between the supporting surface and the portion of the continuous track in contact with the supporting surface.

16. The method of claim 13, wherein varying the pose of the articulated body further comprises cantilevering a portion of the articulated body over a gap in the supporting surface.

17. The method of claim 13, wherein varying the pose of the articulated body further comprises actuating the articulated body so that segments of the articulated body follow each other on a substantially coincident path as the serpentine robotic crawler is moving.

18. The method of claim 17, wherein the path is a curve.

19. The method of claim 13, wherein varying the pose of the articulated body further comprises lifting a leading portion of the articulated body above a supporting surface.
